(19) United States
(12) Patent Application Publication
(10) Pub. No.: US 2025/0145196 A1
(43) Pub. Date: May 8, 2025

(54) SYSTEM AND METHOD FOR OPTIMIZING RAMP OPERATIONS OF A HUB BASED ON A DUAL-STREAM RESOURCE OPTIMIZATION

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,570

(22) Filed: Oct. 10, 2024

Related U.S. Application Data
(63) Continuation-in-part of application No. 18/501,608, filed on Nov. 3, 2023, now Pat. No. 12,217,199.

(51) Int. Cl. B61L 27/16

(52) U.S. Cl. CPC B61L 27/16; B61L 2201/00

(57) ABSTRACT

Systems and techniques for optimizing ramp operations of a hub based on a dual-stream resource optimization (DSRO). In embodiments, inbound and outbound trains scheduled to arrive at or depart from a hub over a planning horizon are identified. A set of candidate track-train assignment sequences involving the inbound and outbound trains and production tracks of the hub facility is generated. Infeasible candidate track-train assignment sequences are eliminated from the set. A cost associated with each remaining candidate track-train assignment sequence over the planning horizon is determined based on one or more effort matrices. An optimized track-train assignment sequence is selected from the set of candidate track-train assignment sequences based on the determined cost. A control signal is automatically sent to a controller to cause execution of the optimized track-train assignment sequence.

### CROSS-REFERENCE TO RELATED APPLICATIONS

The present application is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entirety of which is herein incorporated by reference for all purposes.

### TECHNICAL FIELD

The present disclosure relates generally to resource optimization systems, and more particularly to systems and devices for optimizing ramp operations of a hub based on a dual-stream resource optimization (DSRO).

### BACKGROUND

Intermodal hub facilities are integral to the logistics and transportation sector, acting as central points for the transfer of goods between various transportation modes, including trains, trucks, and ships. The seamless operation of these hubs is a cornerstone for the uninterrupted flow of goods throughout the supply chain, which is increasingly demanding due to the growth in global trade and the push for faster delivery times.

A core activity within these facilities is the management of inbound and outbound train operations. Trains arrive with containers and trailers—key units in intermodal transport—delivering goods to the hub (inbound) or taking goods away towards their final destinations (outbound). The efficiency of handling these units directly impacts the performance of the hub and the broader supply chain.

The resources involved in these operations are diverse and limited, encompassing parking spots, hostlers, cranes, chassis, railcars, locomotives, and tracks. Optimizing the use of these resources is a complex challenge but is also pivotal to improving the hub's throughput and reducing operational costs.

The inbound and outbound flows of units are distinct yet interconnected processes within the hub. Inbound units are typically deconsolidated and prepared for collection by consignees, while outbound units are consolidated and loaded for transport. The synchronization of these flows is a delicate balancing act that requires precise scheduling and resource allocation.

Scheduling the arrival and departure of trains is a multifaceted task that involves not just the timing but also the allocation of tracks and other resources. The goal is to maximize resource utilization and ensure punctual train operations. This scheduling is often facilitated by employing traditional components such as events, jobs, and resources.

A time-space network is a common tool used to visualize and plan the flow of units through a hub over a given period. This graphical representation includes nodes (processes) and edges (capacity), with the time dimension allowing for the analysis of node connectivity and unit flow under various operational scenarios.

In essence, the effective operation of intermodal hub facilities is dependent on the strategic scheduling of trains and the efficient use of resources. This necessitates sophisticated planning and optimization models that can handle the intricate dynamics of unit flows, resource constraints, and temporal factors.

### SUMMARY

The present disclosure achieves technical advantages as systems, methods, and computer-readable storage media for optimizing ramp operations of a hub based on a dual-stream resource optimization (DSRO). The functionality for optimizing ramp operations of a hub is based on a DSRO model that includes both a consolidated time-space network and a deconsolidated time-space network, facilitating the efficient flow of units through the hub from in-gating to out-gating.

In embodiments, the present disclosure provides for a system integrated into a practical application with meaningful limitations as a ramp operations optimization system with functionality for optimizing ramp operations of a hub. In embodiments, the ramp operations optimization system may be configured to identify inbound and outbound trains scheduled to arrive at or depart from a hub over a planning horizon, to generate a set of candidate track-train assignment sequences involving the inbound and outbound trains and production tracks of the hub, to eliminate or prune infeasible candidate track-train assignment sequences from the set, to determine a cost associated with each remaining candidate track-train assignment sequence over the planning horizon based on one or more effort matrices, and to select an optimized track-train assignment sequence from the set of candidate track-train assignment sequences based on the determined cost. The ramp operations optimization system may be configured to automatically send a control signal to a controller to cause execution of the optimized track-train assignment sequence.

A technical improvement of the features provided herein includes the generation of a set of candidate track-train assignment sequences that define the processing of inbound and outbound trains over a planning horizon. This generation process takes into account the predicted volume of units, available resources, and the constraints of the time-space networks, leading to a more dynamic and responsive scheduling system. In addition, eliminating infeasible candidate sequences may ensure that the remaining sequences are viable within the hub's operational constraints. This pruning process is enhanced by evaluating the compatibility of train types and processing requirements, which contributes to the overall efficiency of the hub operations. Moreover, determining costs associated with each candidate sequence based on effort matrices enables the system to quantify, via the effort matrices, the effort and resources involved in processing train pairs, allowing for a comprehensive evaluation of the operational impact of each sequence.

The selection of an optimized track-train assignment sequence is based on the cost determination, using a mathematical optimization model that minimizes the total cost while considering the hub's operational constraints and objectives. This optimization leads to maximized resource utilization, improved on-time performance, and minimized processing times. Furthermore, automatically sending a control signal to a controller to execute the optimized track-train assignment sequence is an automation that represent a technical improvement in the real-time implementation of the optimized operating schedule, enhancing the hub's responsiveness to dynamic operational conditions.

Collectively, these technical improvements provided by the ramp operation optimization functionality of the present disclosure contribute to a more efficient, reliable, and adaptable hub facility, capable of handling the complexities of modern freight transportation.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for optimizing resources in hubs. In doing so, the present disclosure goes well beyond a mere application the manual process to a computer. Accordingly, the disclosure and/or claims herein necessarily provide a technological solution that overcomes a technological problem.

Furthermore, the functionality for optimizing ramp operations in a hub facility provided by the present disclosure represents a specific and particular implementation that results in an improvement in the utilization of a computing system for resource optimization. Thus, rather than a mere improvement that comes about from using a computing system, the present disclosure, in enabling a system to leverage and optimize ramp operations to optimize the unit throughput of the hub over the planning horizon of the optimized operating schedule, represents features that result in a computing system device that can be used more efficiently and is improved over current systems that do not implement the functionality described herein. As such, the present disclosure and/or claims are directed to patent eligible subject matter.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of optimizing ramp operations in a hub facility. It is a further object of the disclosure to provide a system for optimizing ramp operations in a hub facility, and a computer-based tool for optimizing ramp operations in a hub facility. These and other objects are provided by the present disclosure, including at least the following embodiments.

In one particular embodiment, a method of optimizing ramp operations in a hub facility is provided. The method includes identifying inbound and outbound trains scheduled to arrive at or depart from a hub over a planning horizon of an optimized operating schedule based on a dual-stream optimization model including a consolidated time-space network and a deconsolidated time-space network of the optimized operating schedule, and generating a set of candidate track-train assignment sequences involving the inbound and outbound trains and production tracks of the hub facility. In embodiments, each candidate track-train assignment sequence in the set of candidate track-train assignment sequences defines a sequence of track-train assignments for a respective production track of the production tracks over the planning horizon, and a track-train assignments includes an assignment of one of the inbound and outbound trains to a particular production track for processing. The method also includes eliminating infeasible candidate track-train assignment sequences from the set of candidate track-train assignment sequences, determining a cost, based on one or more effort matrices, associated with each remaining candidate track-train assignment sequence in the set of candidate track-train assignment sequences over the planning horizon, selecting an optimized track-train assignment sequence from the set of candidate track-train assignment sequences based on the determined cost, and automatically sending, during execution of the optimized operating schedule, a control signal to a controller to cause execution of the optimized track-train assignment sequence.

In another embodiment, a system for optimizing ramp operations in a hub facility is provided. The system comprises at least one processor and a memory operably coupled to the at least one processor and storing processor-readable code that, when executed by the at least one processor, is configured to perform operations. The operations include identifying inbound and outbound trains scheduled to arrive at or depart from a hub over a planning horizon of an optimized operating schedule based on a dual-stream optimization model including a consolidated time-space network and a deconsolidated time-space network of the optimized operating schedule, and generating a set of candidate track-train assignment sequences involving the inbound and outbound trains and production tracks of the hub facility. In embodiments, each candidate track-train assignment sequence in the set of candidate track-train assignment sequences defines a sequence of track-train assignments for a respective production track of the production tracks over the planning horizon, and a track-train assignments includes an assignment of one of the inbound and outbound trains to a particular production track for processing. The operations also include eliminating infeasible candidate track-train assignment sequences from the set of candidate track-train assignment sequences, determining a cost, based on one or more effort matrices, associated with each remaining candidate track-train assignment sequence in the set of candidate track-train assignment sequences over the planning horizon, selecting an optimized track-train assignment sequence from the set of candidate track-train assignment sequences based on the determined cost, and automatically sending, during execution of the optimized operating schedule, a control signal to a controller to cause execution of the optimized track-train assignment sequence.

In yet another embodiment, a computer-based tool for optimizing ramp operations in a hub facility is provided. The computer-based tool including non-transitory computer readable media having stored thereon computer code which, when executed by a processor, causes a computing device to perform operations. The operations include identifying inbound and outbound trains scheduled to arrive at or depart from a hub over a planning horizon of an optimized operating schedule based on a dual-stream optimization model including a consolidated time-space network and a deconsolidated time-space network of the optimized operating schedule, and generating a set of candidate track-train assignment sequences involving the inbound and outbound trains and production tracks of the hub facility. In embodiments, each candidate track-train assignment sequence in the set of candidate track-train assignment sequences defines a sequence of track-train assignments for a respective production track of the production tracks over the planning horizon, and a track-train assignments includes an assignment of one of the inbound and outbound trains to a particular production track for processing. The operations also include eliminating infeasible candidate track-train assignment sequences from the set of candidate track-train assignment sequences, determining a cost, based on one or more effort matrices, associated with each remaining candidate track-train assignment sequence in the set of candidate track-train assignment sequences over the planning horizon, selecting an optimized track-train assignment sequence from the set of candidate track-train assignment sequences based on the determined cost, and automatically sending, during execution of the optimized operating schedule, a control signal to a controller to cause execution of the optimized track-train assignment sequence.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for optimizing ramp operations of a hub based on a DSRO in accordance with embodiments of the present disclosure.

FIG. 2 is a block diagram illustrating an example of DSRO system configured with capabilities and functionality for optimizing ramp operations of a hub based on a DSRO in accordance with embodiments of the present disclosure.

FIG. 3 is a block diagram of an exemplary ramp operations optimization system configured with functionality for optimizing ramp operations of a hub in accordance with embodiments of the present disclosure.

FIG. 4 illustrates an example of ramp operations over multiple production tracks in a hub.

FIG. 5A illustrates an example of ramp operations for an inbound train in a hub.

FIG. 5B illustrates an example of ramp operations for an outbound train in a hub.

FIG. 6 is a flowchart illustrating operations of a ramp operations optimization system configured with functionality for optimizing utilization of hostler resources of a hub in accordance with embodiments of the present disclosure.

FIG. 7 shows a high-level flow diagram of operation of a system configured for providing functionality for optimizing ramp operations of a hub in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for optimizing ramp operations of a hub based on a dual-stream resource optimization (DSRO). In embodiments, a ramp operations optimization system may be configured to optimize ramp operations of a hub. In embodiments, the ramp operations optimization system may be configured to identify inbound and outbound trains scheduled to arrive at or depart from a hub over a planning horizon, to generate a set of candidate track-train assignment sequences involving the inbound and outbound trains and production tracks of the hub, to eliminate or prune infeasible candidate track-train assignment sequences from the set, to determine a cost associated with each remaining candidate track-train assignment sequence over the planning horizon based on one or more effort matrices, and to select an optimized track-train assignment sequence from the set of candidate track-train assignment sequences based on the determined cost. The ramp operations optimization system may be configured to automatically send a control signal to a controller to cause execution of the optimized track-train assignment sequence.

In embodiments, ramp operations of a hub may refer to both ramping operations in which units are loaded onto a train in a production track, and deramping operations in which units are unloaded from a train in a production track.

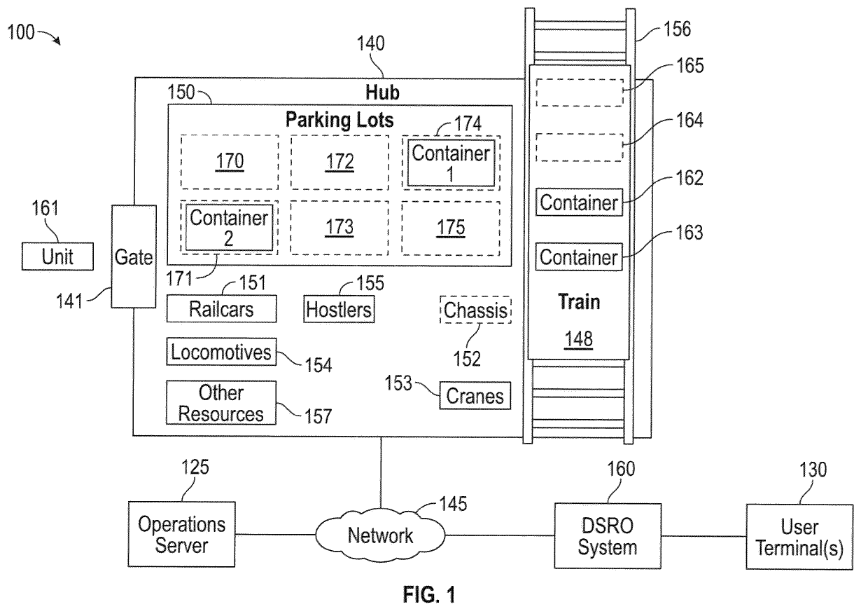

FIG. 1 is a block diagram of an exemplary system 100 configured with capabilities and functionality for optimizing ramp operations of a hub based on a DSRO in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide functionality for managing operations of hub 140 in accordance with embodiments of the present disclosure. For example, an operator may provide information related to train schedules, information related to units arriving at hub 140, information related to configuration of the parking lots within hub 140, information related to production track configurations, to request parking spot assignments, etc. In an additional or alternative example, the operator may receive information related to parking spot assignments for units, such as may receive parking spot assignments, may receive multihop move orders, etc. In embodiments, user terminal 130 may be configured to communicate with other components of system 100.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Hub 140 may represent a hub (e.g., an IHF, a train station, etc.) in which units are processed as part of the transportation of the units. In embodiments, a unit may include containers, trailers, etc., carrying goods. For example, a unit may include a chassis carrying a container, and/or may include a container. In embodiments, units may be in-gated (IG) into hub 140 (e.g., by a customer dropping the unit into hub 140). The unit, including the chassis and the container (e.g., the chassis carrying the container), may be temporarily stored in a parking space of parking lots 150, while the container awaits being assigned to an outbound train. Once assigned to an outbound train, and once the outbound train is assigned to a production track (e.g., production tracks 156), the outbound train is placed on the production track and the container is moved from the parking spot in which the container is currently stored to the production track, where the container is removed from the chassis and the container is loaded or ramped onto the outbound train for transportation to the destination of the container. On the other side of operations, a container carrying goods may arrive at the hub via an inbound (IB) train (e.g., the inbound train may represent an outbound train from another hub from which the container may have been loaded), may be unloaded or deramped from the inbound train and may be temporarily stored in a parking spot of parking lots 150 for eventual pickup by a customer.

Hub 140 may be described functionally by describing the operations of hub 140 as comprising two distinct flows or streams. Units (e.g., containers being carried in chassis) flowing through a first flow (e.g., an IG flow) may be received through gate 141 from various customers for eventual ramping onto an appropriate outbound train. For example, customers may drop off individual units (e.g., unit 161 including a container being carried in a chassis) at hub 140. The containers arriving through the IG flow may be destined for different destinations, and may be dropped off at hub 140 at various times of the day or night. As part of the IG flow, the containers arriving at hub 140, along with the chassis in which these containers arrive, may be assigned or allocated to parking spots in one or more of parking lots 150, while these containers wait to be assigned to and ramped onto an outbound train bound to the respective destination of the containers. Once an outbound train is ready to be ramped, the outbound train (e.g., train 148) may be assigned to and placed on a production track (e.g., production track 156). At this point, the containers assigned to the outbound train may be moved from their current parking spot to the production track to be ramped onto the outbound train to be taken to their respective destination.

Units flowing through a second flow (e.g., an IB flow) may arrive at hub 140 via an inbound train (e.g., train 148 may arrive at hub 140), carrying containers, such as containers 162, 163, and/or other containers, which may eventually be deramped from the inbound train to be placed onto chassis, assigned to and parked in parking spots of parking lot 150 to be made available for delivery to (e.g., for pickup by) customers.

For example, unit 141, including a container being carried in a chassis, may be currently being dropped off into hub 140 by a customer as part of the IG flow of hub 140, and may be destined to a first destination. In this case, as part of the IG flow, unit 141 may be in-gated into hub 140 and may be assigned to a parking spot (e.g., parking spot 175) in one of parking lots 150. In this example, container 1 may have been introduced into the IG flow of hub 140 by a customer (e.g., the same customer or a different customer) previously dropping off container 1 at hub 140 to be transported to some destination (e.g., the first destination or a different destination), and may have previously been assigned to parking spot 174 of parking lots 150, where container 1 may currently be waiting to be assigned and/or loaded onto an outbound train to be transported to the destination of container 1.

As part of the IG flow, the container in unit 141 and container 1 may be assigned to an outbound train. For example, in this particular example, train 148 may represent an outbound train that is schedule to depart hub 140 to the same destination as the container in unit 141 and container 1. In this example, the container in unit 141 and container 1 may be assigned to train 148. Train 148 may be placed on one of one or more production track 156 to be ramped. In this case, as part of the IG flow, train 148 is ramped (e.g., using one or more cranes 153) with containers, including the container in unit 141 and container 1. Once loaded, train 148 may depart to its destination as part of the IG flow.

With respect to the IB flow, train 148 may arrive at hub 140 carrying several containers, including containers 2, 162, and 163. It is noted that, as part of the dual stream operations of hub 140, some resources are shared and, in this example, train 148 may arrive at hub 140 as part of the IB flow before being loaded with containers as part of the IG flow as described above. Train 148 may be placed on one of one or more production tracks 156 to be unloaded a part of the IB flow. As part of the deramping operations, the containers being carried by train 148 and destined for hub 140, may be removed from train 148 (e.g., using one or more cranes 153) and each placed or mounted on a chassis. Once on the chassis, the containers are transported (e.g., using one or more hostlers 155) to an assigned parking spot of parking lots 150 to wait to be picked up by respective customers at which point the containers and the chassis on which the containers are mounted may exit or leave hub 140. For example, container 2 may be assigned to and parked on parking spot 172.

In embodiments, processing the units through the IG flow and the IB flow may involve the use of a wide variety of resources to consolidate the units from customers into outbound trains and/or to deconsolidate inbound trains into units for delivery to customers. These resources may include hub personnel (hostler drivers, crane operators, etc.), parking spaces, chassis, hostlers, cranes, tracks, railcars, locomotives, etc. These resources may be used to facilitate holding and/or moving the units through the operations of the hub.

For example, parking lots 150 may be used to park or store units while the units are waiting to be assigned to and loaded onto outbound trains or waiting to be picked up by customers. Parking lots 150 of hub 140 may include a plurality of parking lots, each of which may include a plurality of parking spots. In the example illustrated in FIG. 1, parking lots may include parking spots 170-175. In embodiments, parking lots 150 may represent physical parking lots that may be configured with a particular layout, orientation with respect to the production tracks of hub 140, and/or distance from the production tracks. In some embodiments, the various parking lots of parking lots 150 may have different categories, based on the accessibility to the production tracks 156 from the respective parking lots. For example, some parking lots may be categorized as beachfront parking lots, high-priority hub parking lots, low-priority hub parking lots, offsite parking lots, stacked parking lots, etc. During operations, units arriving at hub 140 may be allocated to parking lot categories, in which case a unit allocated to a particular parking lot category may be assigned to a parking spot in a parking lot having the allocated particular parking lot category.

Chassis 152 (e.g., including, trucks, forklifts, and/or any structure configured to securely carry a container), and operators of chassis 152, may be used to securely carry units within hub 140. Hostlers 155 (e.g., including hostler operators, etc.) may be used to transport or move the units (e.g., containers on chassis) within hub 140, such as moving units to be loaded onto an outbound train or to move units unloaded from inbound trains. Cranes 153 may be used to load units onto departing trains (e.g., to unload units from chassis 152 and load the units onto the departing trains), and/or to unload units from arriving trains (e.g., e.g., to unload units from arriving trains and load the units onto chassis 152). Railcars 151 may be used to transport the units in the train. For example, a train may be composed of one or more railcars, and the units may be loaded onto the railcars for transportation. Arriving trains may include one or more railcars including units that may be processed through the second flow, and departing trains may include one or more railcars including units that may have been processed through the first flow. Railcars 151 may be assembled together to form a train. Locomotives 154 may include engines that may be used to power a train. Other resources 157 may include other resources not explicitly mentioned herein but configured to allow or facilitate units to be processed through the first flow and/or the second flow.

In embodiments, operations server 125 may be configured to provide functionality for facilitating operations of hub 140. In embodiments, operations server 125 may include data and information related to operations of hub 140, such as current inventory of all hub resources (e.g., chassis, hostlers, drivers, lift capacity, parking lot and parking spaces, IG capacity limits, railcar, locomotives, tracks, etc.). This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon an optimized operating schedule (as described herein), which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop, generate, and/or update an optimized operating schedule based on a DSRO for managing the resources of hub 140 over a planning horizon.

In embodiments, operations server 125 may provide functionality to manage the execution of the optimized operational schedule (e.g., an optimized operating schedule generated in accordance with embodiments of the present disclosure) over the planning horizon of the optimized operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. Particular to the present disclosure, the optimized operating schedule may include recommendations associated with ramping and deramping operations. For example, the optimized operating schedule may include recommendations on which production tracks to assign inbound and outbound trains for processing. Processing an inbound train may include deramping or unloading the units carried in the train and scheduled to be unloaded at the hub. Processing an outbound train may include ramping or loading the units to be carried by the outbound train to their destination.

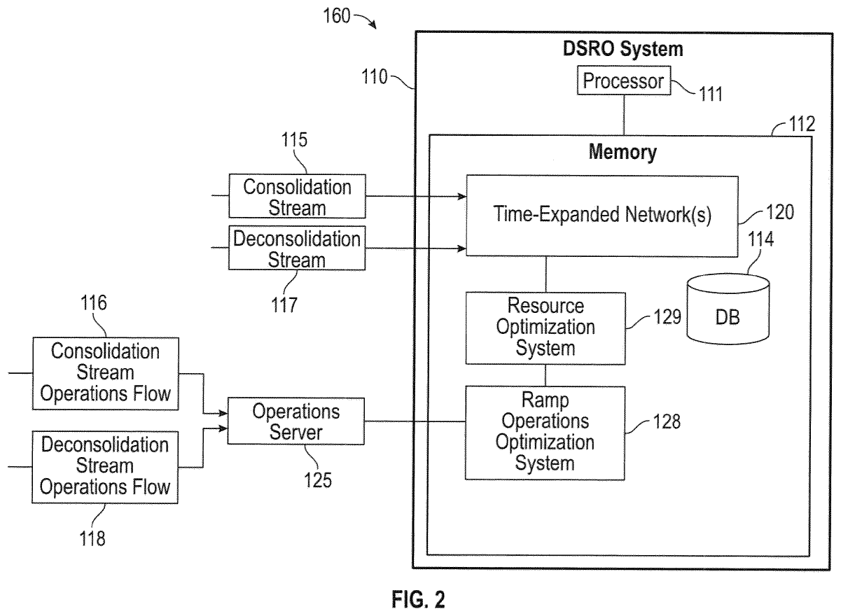

In embodiments, operations server 125 may manage execution of the optimized operational schedule by monitoring the consolidation stream operations flow (e.g., consolidation stream operations flow 116 of FIG. 2, which may represent the actual unit traffic flow through the IG flow during execution of the optimized operating schedule) and deconsolidation stream operations flow (e.g., deconsolidation stream operations flow 118 of FIG. 2, which may represent the actual unit traffic flow through the IB flow during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule. In embodiments, operations server 125 may operate to provide functionality that may be leveraged during execution of the optimized operational schedule over a planning horizon to ensure that unit throughput through the hub is maximized over the planning horizon.

DSRO system 160 may be configured to manage resources of hub 140 based on a DSRO to maximize throughput through hub 140 over the planning horizon in accordance with embodiments of the present disclosure. In particular, DSRO system 160 may be configured to provide the main functionality of system 100 to optimize the ramping operations of hub 140 to generate an optimized ramp plan (e.g., a sequence of track-train assignments of inbound and/or outbound trains, in chronological order) that is configured to maximizing the utilization of the hub resources, and to meet predefined objectives (e.g., maximized on-time-performance, optimized total processing time, optimized track utilization, etc.). In embodiments, DSRO system 160 may optimize the ramping operations of hub 140 over the planning horizon of the optimized operating schedule by leveraging the functionality of a ramping operations optimization system (e.g., ramping operations optimization system 128 of FIG. 2) that may include functionality to dynamically assess hub resource availability at intermediate time increments of the planning horizon and to evaluate the demand for resources by varying sequences of train ramping operations. The ramping operations optimization system meticulously analyzes different permutations of inbound and outbound train sequences (e.g., different sequences of train processing in one or more production tracks) over the planning horizon, along with the requisite intermediate setups, to select the optimum train sequence for each production track within the hub facility based on predetermined effort matrices. The ramping operations optimization system's objectives can be tailored to prioritize on-time performance or to maximize resource utilization, depending on operational priorities.

FIG. 2 is a block diagram illustrating an example of DSRO system 160 configured with capabilities and functionality for optimizing ramp operations of a hub based on a DSRO in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, ramp operations optimization system 128, resources optimization system 129, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a parking lot optimization model, a parking lot classification model, an ingate prediction model, an inbound prediction model, a unit diffusion model, a hostler route operations optimization model, a multihop operations optimization model, a ramp operations optimization model, etc. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of hub 140 may be represented as two distinct flows, an IG flow in which units arriving to hub 140 from customers are consolidated into outbound trains to be transported to their respective destinations, and an IB flow in which inbound trains arriving to hub 140 carrying units are deconsolidated into the units that are stored in parking lots while waiting to be picked up by respective customers. DSRO system 160 may be configured to represent the IG flow as consolidation stream 115 including a plurality of stages. Each stage of consolidation stream 115 may represent different operations or events that may be performed or occur to facilitate the IG flow of hub 140. DSRO system 160 may be configured to represent the IB flow as deconsolidation stream 117 including a plurality of stages. Each stage of deconsolidation stream 117 may represent different operations or events that may be performed or occur to facilitate the IB flow of hub 140.

Each of the consolidation stream 115 and deconsolidation stream 117 may include various stages. For example, consolidation stream 115 may be configured to include a plurality of stages, namely an in-gated (IG) stage, an assignment (AS) stage, a ramping (RM) stage, a release (RL) stage, and a departure (TD) stage. Deconsolidation stream 115 may be configured to include a plurality of stages, namely an arrival (TA) stage, a strip track placement (ST-PU) stage, a de-ramping (DR) stage, a unit park and notification (PN) stage, and an out-gated (OG) stage. In embodiments, each of the stages of each of consolidation stream 115 and deconsolidation stream 117 may represent an event or operations that may be performed or occur to facilitate the flow of a unit through each of the streams.

In particular, the RM stage of consolidation stream 115 may represent ramping operations of the IG flow in which units may be loaded onto an outbound train for transportation to the destination of the container. In embodiment, during the RM stage, the units may be assigned to a railcar of an outbound train, such as based on the unit's destination and/or the desired delivery time, such as based on a scheduled train lineup. During this stage, the outbound train may be assigned to a production track and may be placed in the production track for loading. In particular, the RM stage of consolidation stream 115 may operate to consolidate containers with a same destination (or with a destination that is within a particular route) into the outbound train. During the RM stage of consolidation stream 115.

In embodiments, at the ST-PU stage of deconsolidation stream 117, an inbound train may be spotted and placed on a production track for unloading. In embodiments, the resources involved in the ST-PU stage may include the production tracks used to place the inbound train, the locomotive used to power the inbound train into the production track, and the railcars that are part of the inbound train. The DR stage of deconsolidation stream 117 may represent deramping operations of the IB flow. During the DR stage, units being carried by the inbound train may be unloaded or deramped from the inbound train. Again, a host of hub resources may be used during the DR stage of deconsolidation stream 117.

In embodiments, DSRO system 160 may be configured to optimize the use of resources and operations to maximize the throughput of the hub (e.g., the rate of units processed through the hub) by generating one or more time-expanded networks 120 to represent consolidation stream 115 and deconsolidation stream 117, and configuring the DSRO model to use one or more time-expanded networks 120, over a planning horizon, to optimize the use of the resources of the hub that support the unit flow within the planning horizon to maximize the throughput of units over the planning horizon. In embodiments, the DSRO model may generate, based on the one or more time-expanded networks 120, an optimized operating schedule that includes one or more of a determined unit flow through one or more of the stages of time-expanded network (e.g., the consolidation and/or deconsolidation stream time-expanded networks) at each time increment of the planning horizon, an indication of a resource deficit or overage at one or more of the stages of each time-expanded network at each time increment of the planning horizon, and/or an indication or recommendation of a resource replenishment to be performed at one or more of the stages of each time-expanded network at each time increment of the planning horizon to ensure the optimized operating schedule is met.

Particular to the present disclosure, the optimized operating schedule may include recommendations for ramping and/or deramping operations at each time increment of the planning horizon of the optimized operating schedule configured to maximize the unit throughput within the hub during execution of the optimized operating schedule. The ramping and/or deramping operation recommendations may include recommendations on how to perform ramping operations and/or deramping operations at each time increment of the planning horizon, as well as recommendations related to the assignment of trains (e.g., inbound and/or outbound trains) to production tracks, which may be referred to as track-train assignments, for processing of the trains (e.g., for unlading or deramping and/or loading or ramping). In this manner, during execution of the optimized operating schedule, operators may perform ramping operations and/or deramping operations according to the recommendations in the optimized operating schedule to ensure that the unit throughput of the hub over the planning horizon of the optimized operating schedule is maximized.

In embodiments, DSRO system 160 may be configured to apply the DSRO model to the time-expanded networks 120 to optimize the use of the by the consolidation and deconsolidation streams over the planning horizon to maximize the unit throughput of the hub over the planning horizon to generate the optimized operating schedule. To that end, DSRO 160 may include a plurality of optimization systems. For example, resource optimization system 129 may be configured to generate, based on the DSRO model, an optimized operating schedule that may be implemented over a planning horizon to maximize throughput of units through the hub. In particular, resource optimization manager 129 may be configured to consider resource availability (e.g., resource inventory), resource replenishment cycles, resource cost, operational implications of inadequate supply of resources, for all the resources involved in the consolidation and deconsolidation streams to determine the optimized operating schedule that may maximize throughput through the hub over the planning horizon. Resource optimization manager 129 may be configured to additionally consider unit volumes (e.g., unit volumes expected to flow during the planning horizon through the consolidation stream and the deconsolidation streams, such as at each time increment of the planning horizon) and unit dwell times (e.g., expected dwell times of units flowing through the consolidation stream and the deconsolidation streams during the planning horizon) to determine the optimized operating schedule that may maximize throughput through the hub over the planning horizon.

During operations (e.g., during execution of the operating schedule, when units arrive at the hub), operations server 125 may operate to manage execution of the optimized operational schedule by monitoring consolidation stream operations flow 116 (e.g., the actual traffic flow through the consolidation stream 115 during execution of the optimized operating schedule) and deconsolidation stream operations flow 118 (e.g., the actual traffic flow through the deconsolidation stream 117 during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, the functionality of DSRO system 160 to optimize the ramp operations of the hub may include leveraging the functionality of ramp operations optimization system 128. Ramp operations optimization system 128 may be configured to optimize ramp operations of the hub by dynamically assessing resource availability at time increments of the planning horizon and evaluating the demand for resources by varying sequences of ramp operations. For example, ramp operations optimization system 128 may analyze different permutations of inbound and outbound train processing sequences (e.g., different sequences of processing (e.g., deramping or ramping inbound and/or outbound trains) of trains in chronological order for each of the production tracks) over the planning horizon, along with the requisite intermediate setups, to select the optimal train sequence for each production track within the hub facility.

A distinctive attribute of ramp operations optimization system 128 is its capability for intelligent train matching, which involves a detailed quantification of the effort and resources necessitated to facilitate a seamless transition between paired trains in a sequence. This quantification process takes into account the specific resources and subprocesses that are uniquely associated with each pair of trains being matched, enabling a more efficient and synchronized ramp operation sequence. Ramp operations optimization system 128's innovative approach to pairing trains does not merely aligns with the temporal and spatial constraints of the hub's operations but also enhances the overall throughput and performance of the hub.

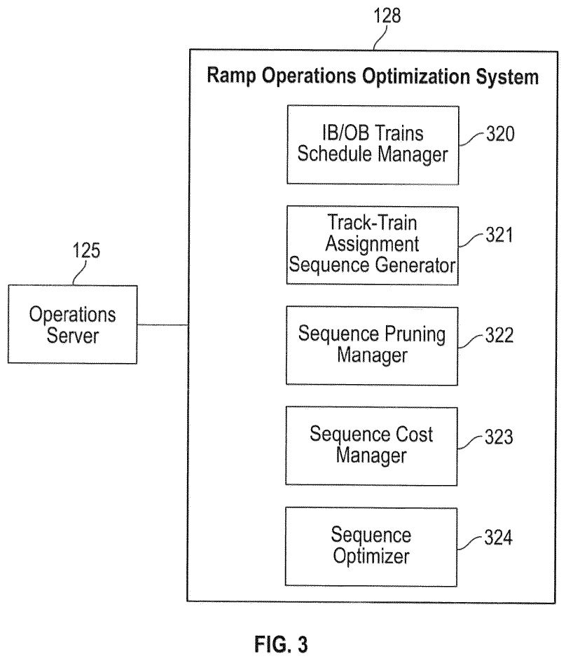

Operations of ramp operations optimization system 127 will now be discussed with respect to FIG. 3. FIG. 3 is a block diagram of an exemplary ramp operations optimization system 128 configured with functionality for optimizing ramp operations of a hub in accordance with embodiments of the present disclosure.

As noted above, scheduling IB and outbound trains (e.g., scheduling the processing of IB and outbound trains in which the IB and outbound trains are assigned to production tracks to be loaded or unloaded) is a pivotal activity that generates the train lineup or sequence (e.g., the chronological sequence in which IB and/or outbound trains are processed in a production track), which is instrumental in determining how hub resources are allocated to maintain peak hub operations. As also mentioned above, units flow through the hub across two streams (e.g., consolidation and deconsolidation streams) having multiple stages. When represented as dual-based time-expanded networks overlayed onto each other, some of the stages overlap, and the TD stage of the consolidation stream may cap the process flow for units entering the hub, while the TA stage of the deconsolidation stream may start the corresponding flow for inbound units. In embodiments, the TD and TA stages may collaboratively determine the complementary handoffs, as well as the timing and replenishment volumes, for the majority of the resources involved between one stage and the other. In addition, the train types, which may define the composition of a train, may be utilized to ascertain the resources that will be required for processing a particular train. By sequencing the IB and/or outbound trains according to their departure times, ramp operations optimization system 127 may identify the transfer of resources such as railcars and locomotives from one train to the next in the sequence. IB and outbound trains function as both supply and demand nodes, mutually supporting one another, and concurrently processed trains vie for hub-supplied resources, including hostlers, parking spots, lift capacity, and more.

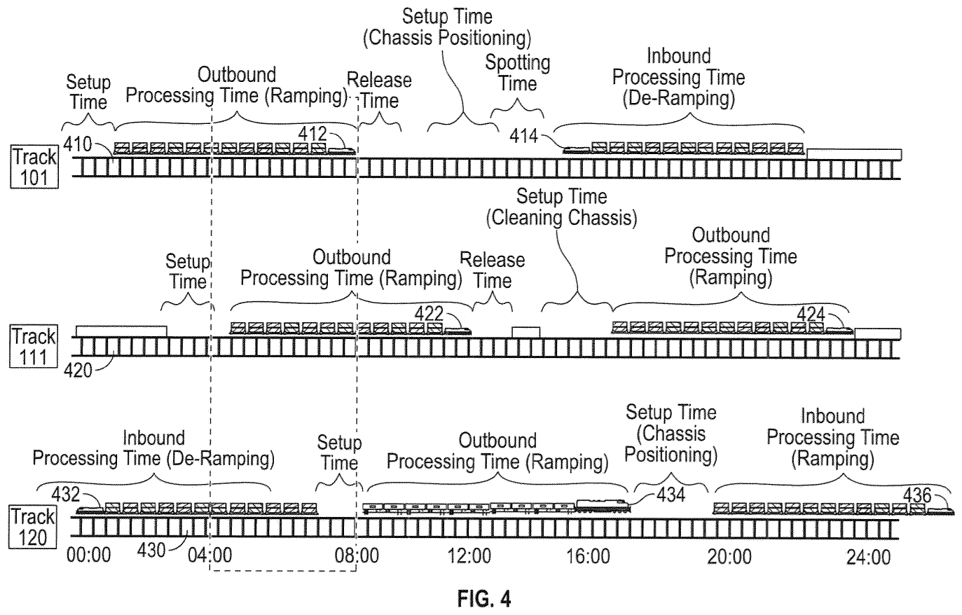

FIG. 4 illustrates an example of ramp operations over multiple production tracks in a hub. In particular, FIG. 4 depicts the dynamic interplay between IB and outbound trains as they are processed through the hub's production tracks over a particular time (e.g., in this example from 00:00 to 24:00 hours), concurrently and sequentially. Specifically, FIG. 4 shows how outbound train 412 is processed in production track 410 and subsequently, inbound train 414 is processed in the same production track 410. However, there is also shown a setup time that is taken before outbound train 412 is processed, as well as a release time after outbound train 412 is processed, a setup time to prepare the production track 410 for processing inbound train 414, and a spotting time to bring inbound train 414 to production track 410. Similarly, on production track 420, outbound train 422 is processed and once completed, outbound train 424 is also processed. It is noted that in this case, there may not be a need to spot outbound train 424, which may result in a shorter time between the processing of outbound train 422 and outbound train 424, when compared to the time between the processing of outbound train 412 and inbound train 414, which require spotting. Similarly, on production track 430, inbound train 432 is processed and once completed, outbound train 434 is also processed. Once outbound train 434 processing is completed, outbound train 436 is also processed. In this example, these trains are processed through the hub over the period of time. This illustrates how processing a train requires resources and activities, which may take time, and may affect the unit throughput of the hub, as the production track has to be prepared for processing the subsequent train. However, not all trains are created equal and as such, the resources and activities required may depend heavily on the type of trains being processed.

In addition, FIG. 4 shows that over some periods of the time between 00:00 and 24:00, some trains are concurrently processed, at least in part, each in their respective production track (e.g., track 410, 420, and 430, respectively). In this case, the competition for resources may be higher than the resource interaction of sequential trains. For example, trains scheduled to be processed on the same track one after the other could feed each other, depending on respective train types. An inbound ‘Z’ train could bring in railcars and locomotives that could be used to build an outbound ‘Z’ train. But a pair of dissimilar train types could raise different resource requirements and set up time to align resources between them. On the other hand, trains scheduled to be processed concurrently compete for such common resources as parking spaces, hostlers, personnel, and lift capacity.

For example, FIG. 4 illustrates several scheduling scenarios that illustrate different configuration of resources needed and activities performed to conduct the processing of the trains. In particular, the scheduling scenarios discussed herein may involve a pair of trains scheduled one after the other (e.g., a pair or matched trains). A first scheduling scenario may include concurrent outbound trains. For example, outbound train 412 and outbound train 422 may be scheduled to be concurrently processed at productions tracks 410 and 420, respectively. The concurrent processing may occur from approximately 04:00 hours to approximately 08:00 hours. In this example, the resources involved to process this concurrent outbound train assignment pair may include twice as many parking lots to hold the units being ramped and twice as many railcars for building the outbound trains than if there was no concurrent processing. In this example, the activities performed to conduct the processing of the concurrent outbound trains may include hostler moves of which half are non-productive hostler moves, clearing chassis from outbound train 412 could delay setup for the outbound train 422 (e.g., may lead to a higher setup time for outbound train 422), and there may be a chassis surplus after both outbound trains are processed.

A second scheduling scenario may include concurrent inbound and outbound trains. For example, inbound train 432 and outbound train 412 may be scheduled to be concurrently processed at productions tracks 430 and 410, respectively. The concurrent processing may occur from approximately 01:00 hours to approximately 06:00 hours. In this example, the resources involved to process this concurrent inbound-outbound train assignment pair may include parking spots cleared by the loading of outbound train 412 may be assigned to the units unloaded from inbound rain 432, the chassis released by the loading of outbound train 412 may be used by the units unloaded from inbound rain 432, the railcars from inbound train 432 may be rearranged for use by outbound train 412, and the locomotives use to move inbound train 412 may be assigned to move outbound train 432. In this example, the activities performed to conduct the processing of the concurrent inbound-outbound trains may include hostler moves associated with inbound-outbound trains may be paired together to increase unit throughput, and the setup for outbound train 412 may be quicker than the set up for inbound train 432.

A third scheduling scenario may include concurrent inbound trains (not shown in FIG. 4). In this case, a first inbound train and a second inbound train may be scheduled to be concurrently processed at respective productions tracks. In this example, the resources involved to process this concurrent inbound-inbound train assignment pair may include twice as many parking lots to hold the units to be deramped, twice as many chassis to secure the units to be deramped, twice as many railcars used by the inbound trains, and twice as many locomotives to move the inbound train, than if there was no concurrent processing of the inbound trains pair. In this example, the activities performed to conduct the processing of the concurrent inbound-outbound trains may include hostler moves of which half are non-productive hostler moves, and clearing chassis from the first inbound train could delay setup for the second inbound train (e.g., may lead to a higher setup time for the second inbound train).

Before delving into the specific functionality of ramp operations optimization system 127, a description is presented of what is entailed in ramp operations, particularly in ramping an outbound train and deramping of an inbound train, and the precedence among the activities those jobs are comprised of.

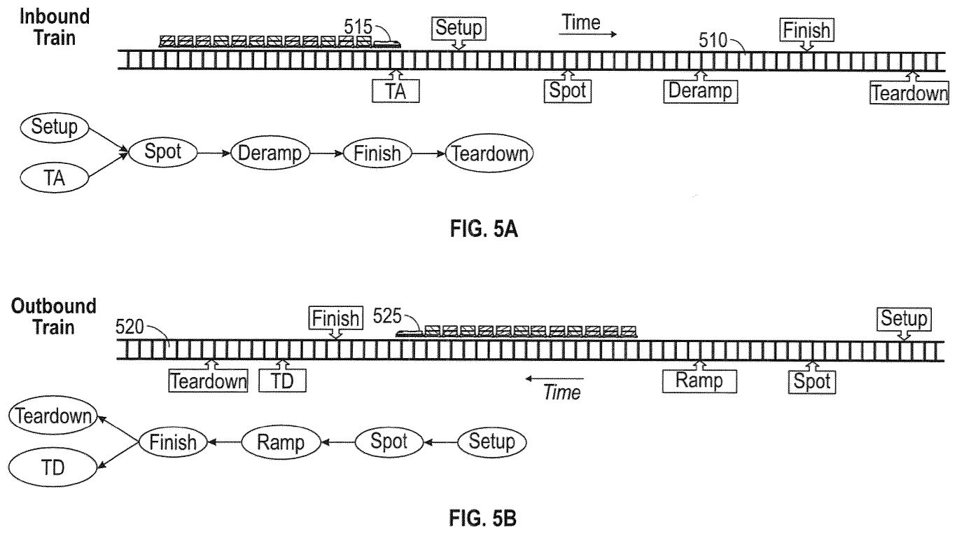

FIGS. 5A and 5B illustrate examples of ramp operations for inbound and outbound trains in a hub. FIG. 5A, in particular, illustrates an example of ramp operations for an inbound train in a hub. As shown in FIG. 5A, inbound train 515 may arrive and may be processed on production track 510. This visual representation emphasizes the specific operations associated with handling inbound trains within the hub facility.

Inbound train 515 is depicted at a point in time when it is being processed. Prior to the arrival and processing of inbound train 515 on production track 510, as illustrated in FIG. 5A, a series of preparatory setup activities are conducted by the hub operations team. These activities are tailored to the specific train type, with particular procedures for train types “Z,” (e.g., high-priority intermodal trains) “S,” (e.g., doublestack trains) “Q,” (e.g., guaranteed intermodal service trains) and/or “P” (e.g., premium trains). For example, if the train type being processed is either ‘S’ or ‘Q’, then chassis may need to be positioned next to the trackside during setup in accordance with the order of containers on that train. In addition, the chassis pool, incoming container size, and the chassis left behind trackside by the previous train processed in production track 510 may decide the extent of the setup effort cost.

Upon the arrival of inbound train 515, if production track 510 is available, the train is spotted—positioned for processing—and deramping operations commence. Deramping involves the unloading of units from the train, which may include containers, vehicles, or other cargo. Following the completion of the unloading process, a teardown phase is initiated. During this teardown phase, the railcars and locomotive—or power—of inbound train 515 may be repositioned for subsequent use or maintenance. This repositioning is a final activity in the processing of inbound train 515 and is integral to maintaining the operational flow within the hub. The teardown phase is carefully managed to minimize downtime and ensure that production track 510 is promptly prepared for the next scheduled train.

In some cases, some of the activities involved in the ramp operations of inbound train 515 may be conducted in parallel, provided the resources needed are available. For example, the setup activity may be conducted concurrently with the inbound train arrival. In this case, chassis may be relocated to trackside if the production track and hostlers are available before or during train arrival to get a head start.

FIG. 5B illustrates an example of ramp operations for an outbound train in a hub. As shown in FIG. 5B, outbound train 525 may be positioned on production track 520, where a series of setup activities are undertaken prior to the train's departure to load outbound train 525. These activities are standard procedures that are integral to the efficient operation of outbound logistics within the hub facility.

The setup process for outbound train 525 includes the strategic positioning of railcars, which are the primary components of the train consist. This involves arranging the railcars in a specific order that aligns with the loading plan and adheres to train rules. Additionally, securing a production track, such as production track 520, is a prerequisite for the setup activities. The production track serves as the staging area for the train consist assembly and loading operations.

Once the setup is complete, outbound train 525 is spotted on production track 520, indicating that it is in position and ready for the loading of intermodal units to commence. The loading process is conducted in accordance with predefined train rules, which dictate the manner in which cargo is loaded onto the train to ensure safety, balance, and compliance with transportation regulations. After the train consist has been fully assembled and loaded, a thorough inspection is carried out to verify that outbound train 525 meets all operational and safety standards. This inspection is a mandatory step that precedes the release of the train for departure from the hub.

As outbound train 525 is released and prepared for departure, teardown activities may be initiated in parallel. These activities may include the clearing of the production track, the repositioning of equipment, and the preparation of the track for the next scheduled train.

With reference back to FIG. 3, ramp operations optimization system 128 may be configured to manage the complex interplay of resources within the hub, where the scheduling of inbound and outbound trains is a pivotal factor in the efficient utilization of hub resources. Ramp operations optimization system 128 may be configured to prevent resource shortages by optimizing the sequence in which trains are scheduled and/or processed, leveraging and even fostering a symbiotic relationship between inbound and outbound trains. This optimization ensures that resources are shared effectively, and trains support each other's operations, rather than competing for resources in a manner that could be detrimental to overall hub efficiency.

In embodiments, ramp operations optimization system 128 may leverage the distinct characteristics of train types to dictate the specific resources that will be utilized for ramping (loading) and deramping (unloading) processes. By intelligently pairing trains on the same production track, ramp operations optimization system 128 may substantially reduce the demand for resources and decrease processing times. For example, the departure of an outbound ‘Q’ train may leave a number of chassis adjacent to the production tracks, which may be efficiently reused by an incoming ‘Q’ train. This strategic pairing allows for a seamless transition of resources from one train to another, minimizing the time and effort spent in repositioning these assets. Conversely, the arrival of a train type that is not compatible with the resources left by the previous train, such as an incoming ‘Z’ train following an outbound ‘Q’ train, would necessitate additional steps. In such scenarios, ramp operations optimization system 128 is capable of directing hub personnel to clear the production track of the existing chassis before the new train can be spotted. This ensures that the transition between different train types is managed effectively, without causing undue delays or resource wastage.

Ramp operations optimization system 128 represents a sophisticated system that not merely schedules trains but also orchestrates the allocation and reallocation of resources in real-time. It takes into account the dynamic nature of hub operations, responding to changes in train schedules, resource availability, and operational demands. By doing so, ramp operations optimization system 128 maximizes the unit throughput of the hub, enhances on-time performance, and ensures that the hub operates at peak efficiency.

As shown in FIG. 3, ramp operations optimization system 128 may include IB/OB train schedule manager 320, track-train assignment sequence generator 321, sequence pruning manager 322, sequence cost manager 323, and sequence optimizer 324

IB/OB train schedule manager 320 may be configured to obtain or identify inbound and outbound trains slated to traverse the hub within the planning horizon of the optimized operating schedule. This identification process leverages the operations server 125, which serves as a repository and management system for active train schedules-those trains that are confirmed to arrive at or depart from the hub. Additionally, the identification of the inbound and outbound trains may be based on predictive analytics, utilizing historical data to forecast train schedules that are not yet confirmed but are likely based on past trends and patterns.

This comprehensive set of inbound and outbound trains, encompassing both confirmed and predicted schedules, represents the aggregate demand that the ramp operations optimization system 128 is tasked with accommodating over the planning horizon. The optimization system 128, therefore, utilizes this information to meticulously plan and coordinate ramp operations, ensuring that the hub's resources are allocated in the most efficient manner possible to meet this demand.

The predictive component of the IB/OB train schedule manager 320 is particularly instrumental in preempting potential bottlenecks and resource constraints. By anticipating train movements before they are officially scheduled, the ramp operations optimization system 128 can proactively adjust resource allocation, mitigating the risk of operational disruptions. This forward-looking approach is a cornerstone of the system's ability to maintain a seamless flow of train movements through the hub, optimizing the utilization of tracks, personnel, and equipment.

In essence, the IB/OB train schedule manager 320 functions as the strategic linchpin of the ramp operations optimization system 128, providing a dynamic and comprehensive overview of train movements that informs all subsequent optimization processes. Through its integration with the operations server 125 and its advanced predictive capabilities, the schedule manager 320 ensures that the ramp operations optimization system 128 is equipped with the real-time and forecasted data it requires to execute an optimized operating schedule that is both responsive and resilient to the ever-changing demands of hub operation.

Track-train assignment sequence generator 321 may be configured to generate a set of candidate track-train assignment sequences over the planning horizon for each production track and the inbound and outbound trains identified. Each candidate track-train assignment sequence may define a sequence of track-train assignments for a respective production track over the planning horizon. A track-train assignment includes an assignment of one of the inbound and outbound trains to a particular production track for processing. For example, a train-track assignment sequence may include a sequence OB1-IB1-OB2-OB3-IB2 in which the sequence of assignments, in chronological order for the respective production track, includes assigning first outbound train OB1 to the production track, followed by first inbound train IB1, followed by second outbound train OB2, followed by third outbound train OB3, followed by second inbound train IB2. In this manner, first outbound train OB1 may be processed first in the production track, followed by first inbound train IB1, followed by second outbound train OB2, followed by third outbound train OB3, followed by second inbound train IB2.

In embodiments, the generation of the set of candidate track-train assignment sequences may take into account the identified inbound and outbound trains, the available production tracks, and the predicted unit volumes, as well as the constraints and objectives of the dual-stream optimization model. In generating these candidate track-train assignment sequences, track-train assignment sequence generator 321 may build the sequences from the identified inbound and outbound trains slated to traverse the hub within the planning horizon of the optimized operating schedule by putting together any possible permutation of trains, based on their scheduled processing time.

In particular embodiments, building each of the candidate track-train assignment sequences in the set of candidate track-train assignment sequences may include identifying suitable train pairs, and building the candidate track-train assignment sequences from the suitable train pairs. For example, track-train assignment sequence generator 321 may identify the resources involved for each identified inbound and outbound trains, such as based on train type, priority levels, composition, consist details, etc. Track-train assignment sequence generator 321 may then determine resource consumed by each of the identified inbound and outbound trains (e.g., railcars, locomotives, parking spots, chassis, hostlers, cranes, etc.) during processing. Track-train assignment sequence generator 321 may then determine resources supplied (e.g., freed up) by each of the identified inbound and outbound trains during processing. Track-train assignment sequence generator 321 may generate train pairs matching two trains to be processed based on their resource compatibility, overlap, and/or effort needed for processing each pair. Track-train assignment sequence generator 321 may then compute setup, processing (ramp/deramp), finishing, and post-processing times for each possible train pair. From this, track-train assignment sequence generator 321 may enumerate possible sequences made of train pairs that fit within the planning horizon to generate the set of candidate track-train assignment sequences.

In particular embodiments, the construction of each candidate track-train assignment sequence within the set of candidate track-train assignment sequences may entail the identification of suitable train pairs, followed by the assembly of the candidate track-train assignment sequences from these suitable train pairs. Track-train assignment sequence generator 321 is configured to discern the resources implicated for each identified inbound and outbound train, such as based on train type, priority levels, composition, consist details, and other pertinent factors.

Once the relevant resources for each train are identified, track-train assignment sequence generator 321 proceeds to ascertain the resources consumed by each of the identified inbound and outbound trains during processing. These resources may encompass railcars, locomotives, parking spots, chassis, hostlers, cranes, and the like. Concurrently, the track-train assignment sequence generator 321 evaluates the resources that are supplied or liberated by each of the identified inbound and outbound trains as a result of processing activities.

With this information, the track-train assignment sequence generator 321 may generate train pairs by matching two trains that are to be processed concurrently or sequentially, based on their resource compatibility, the degree of overlap in resource utilization, and the effort necessitated for processing each pair (e.g., for setup). This matching process is a strategic endeavor that aims to optimize the use of resources and streamline the processing of trains within the hub facility.

Subsequently, track-train assignment sequence generator 321 computes the setup times, processing times (which may include ramping up and deramping operations), finishing times, and post-processing times for each potential train pair. These temporal calculations are integral to understanding the duration of each phase of train processing and ensuring that the scheduling of train pairs aligns with the operational cadence of the hub.

From these computations, track-train assignment sequence generator 321 may enumerate potential sequences composed of train pairs that conform to the constraints of the planning horizon. This enumeration results in the generation of the set of candidate track-train assignment sequences, which are then subjected to further evaluation and optimization processes to ensure the efficient and effective operation of the hub facility. The candidate sequences that emerge from this process represent a refined selection of potential operational plans, each designed to maximize the utilization of resources and minimize processing times within the hub's ramp operations.

Sequence pruning manager 322 may be configured to identify and eliminate or prune infeasible sequences from the set of candidate track-train assignment sequences. Sequence pruning manager 322 may determine a sequence to be infeasible in response a determination that two trains in the sequence are scheduled in such close temporal proximity that the processing of one train cannot be completed before the other is due to be processed. Additionally, sequences may be deemed infeasible if they are not plausible in terms of the availability or sufficiency of resources, inputs, or other operational constraints. Sequence pruning manager 322 may evaluate each candidate sequence against the hub's operational parameters and resource capacities to ensure that all remaining sequences are viable and can be executed within the established framework of the hub's ramp operations. This pruning process is a pivotal step in streamlining the selection of the optimized track-train assignment sequence, as it effectively reduces the complexity of the decision-making process by focusing on sequences that are practical and executable within the hub's operational context.

In determining candidate track-train assignment sequences to prune, sequence pruning manager 322 may consider all available resources at the hub facility over the planning horizon. These resources can include, for example, the number of available production tracks, the number of available hostlers, the available lift capacity, the available parking spaces, etc. The availability of these resources can influence the feasibility and efficiency of the track-train assignments, and thus can play a role in the generation of the candidate track-train assignment sequences.

For example, the set of candidate track-train assignment sequences may include a first sequence in which three concurrent outbound trains and one sequential outbound train are to be processed during a first shift. In this case, sequence pruning manager 322 may determine that the first shift is predicted to suffer a shortage of railcars and locomotives, and because of the shortage there may not be sufficient resources to process the three concurrent outbound trains and the one sequential outbound train and as such, the first sequence may not feasible. In response to this determination, sequence pruning manager 322 may determine to prune or discard the first sequence from the set of candidate track-train assignment sequences.

In another example, the set of candidate track-train assignment sequences may include a second sequence in which three concurrent outbound trains are to be processed during the first shift. In this case, sequence pruning manager 322 may determine that that number of chassis and parking spots predicted to be available during the first shift may not be sufficient to support the concurrent ramping of the three concurrent outbound trains during the first shift and as such, the second sequence may not feasible. In response to this determination, sequence pruning manager 322 may determine to prune or discard the second sequence from the set of candidate track-train assignment sequences.

In still another example, the set of candidate track-train assignment sequences may include a third sequence in which three outbound trains and one inbound train are to be processed during the first shift. In this case, sequence pruning manager 322 may determine that the inventories predicted to be available during the first shift are sufficient to allow the ramping of the three outbound trains and the deramping of the inbound train. As such, the third sequence may be determined to be feasible. In response to this determination, sequence pruning manager 322 may determine to keep the second sequence in the set of candidate track-train assignment sequences.

Sequence cost manager 323 may be configured to determine the cost associated with each candidate track-train assignment sequence in the pruned set of candidate track-train assignment sequences. In embodiments, the cost associated with each candidate track-train assignment sequence maybe determined in terms of resource sharing between the trains in the sequence during processing, in terms of effort needed to setup for processing each of the trains in the sequence, etc. In embodiments, sequence cost manager 323 may determine the cost based on one or more effort matrices.

In embodiments, the effort matrices may include comprehensive tools that delineate the various activities and resources requisite for the processing of a pair of matched trains within a sequence. Sequence cost manager 323 may calculate the cost of each pair within a sequence to determine the overall cost of the sequence. The effort matrices account for the intricacies of resource sharing and the efforts involved in the setup, processing, and teardown phases of train operations.

To elaborate, the effort matrices may include detailed parameters such as the time and personnel requirements for loading and unloading cargo, the utilization of equipment like cranes and hostlers, and the allocation of track space. They may also factor in the transition times between consecutive train assignments on the same production track, ensuring that the sequences allow for adequate preparation and completion of all operational tasks without overlap or conflict.

In embodiments, the effort matrices may be based on the type of trains being scheduled for processing. For example, Table 1 below shows an example of an effort matrix that sequence cost manager 323 may utilize for determining the cost of an inbound-outbound pair, in which an inbound train is processed first, followed by an outbound train (e.g., IB→OB). As can be seen, Table 1 shows the cost of processing the inbound-outbound pair in terms of setup and resources shared for various types of trains (e.g., Z, Q, and S).

TABLE 1
Inbound-Outbound Pair Effort Matrix

| Setup (Time and effort | | | | |
|---|---|---|---|---|
| needed to prepare for the | | | | |
| second train once the first | | Following Train Type (Outgoing) [symbol] | | |
| train has been processed) | | Z | Q | S |
| Preceding | Z | Little effort needed | Well cars need to be brought | Deep well cars need to be |
| Train Type | | Hitches may need to be | in | brought in |
| (Incoming → | | inspected. | Flat cars freed need to be | More hostlers needed |
| Deramped) | | | cleared | Flat cars freed need to be |
| [symbol] | | | | cleared |
| | Q | Railcars with hitches need | Little effort needed | More hostlers needed |
| | | to be brought in | Chassis may need to be | Deep well cars may be |
| | | Well cars need to be cleared | rearranged | needed |
| | S | Railcars with hitches need | Deep well cars my substitute | Little effort may be needed |
| | | to be brought in | Well cars may be needed | |
| | | Well cars need to be cleared | | |

As can be seen, Table 1 shows the cost of processing the inbound-outbound pair in terms of setup and resources shared for various types of trains (e.g., Z, Q, and S).

Table 2 below shows an example of an effort matrix that sequence cost manager 323 may utilize for determining the cost of an outbound-inbound pair, in which an outbound train is processed first, followed by an inbound train (e.g., OB→IB).

TABLE 2
Outbound-Inbound Pair Effort Matrix

| Setup (Time and effort | | | | |
|---|---|---|---|---|
| needed to prepare for the | | | | |
| second train once the first | | Following Train Type (Incoming) [symbol] | | |
| train has been processed) | | Z | Q | S |
| Preceding | Z | Little effort needed | Chassis need to be fetched | Chassis need to be fetched and |
| Train Type | | | and positioned trackside | positioned trackside |
| (Outbound → | | | | More parking spaces needed |
| Ramped → | Q | Chassis need to be | Little effort needed | Chassis need to be shuffled |
| Departed) ¹ | | cleared | Chassis may need to be | Additional chassis may be |
| | | | rearranged (depending on | needed |
| | | | overlap) | |
| | S | Chassis need to be | Extra chassis may need to | Chassis may need to be shuffled |
| | | cleared | be moved from trackside to | to align with incoming train |
| | | | inventory | consist |
| | | | Remaining chassis need to | |
| | | | be rearranged | |

As can be seen, Table 2 shows the cost of processing the outbound-inbound pair in terms of setup and resources shared for various types of trains (e.g., Z, Q, and S).

Table 3 below shows an example of an effort matrix that sequence cost manager 323 may utilize for determining the cost of an inbound-inbound pair, in which an inbound train is processed first, followed by another inbound train (e.g., IB→IB).

TABLE 3
Inbound-Inbound Pair Effort Matrix

| Setup (Time and effort | | | | |
|---|---|---|---|---|
| needed to prepare for the | | | | |
| second train once the first | | Following Train Type (Incoming) [symbol] | | |
| train has been processed) | | Z | Q | S |
| Preceding | Z | Flat cars need to be | Chassis need to be fetched | Chassis need to be fetched |
| Train Type | | cleared | from the inventory and | from the inventory and |
| (Inbound → | | | positioned | positioned |
| Deramped) ¹ | | | Flat cars need to be cleared | Flat cars need to be cleared |
| | Q | Well cars need to be | Chassis need to be fetched | Chassis need to be fetched |
| | | cleared | from the inventory and | from the inventory and |
| | | | positioned | positioned |
| | | | Well cars need to be cleared | Well cars need to be cleared |
| | S | Well cars need to be | Chassis need to be fetched | Chassis need to be fetched |
| | | cleared | from the inventory and | from the inventory and |
| | | | positioned | positioned |
| | | | Well cars need to be cleared | Well cars need to be fetched |

As can be seen, Table 3 shows the cost of processing the inbound-inbound pair in terms of setup and resources shared for various types of trains (e.g., Z, Q, and S).

Table 4 below shows an example of an effort matrix that sequence cost manager 323 may utilize for determining the cost of an outbound-outbound pair, in which an outbound train is processed first, followed by another outbound train (e.g., OB→OB).

TABLE 4
Outbound-Outbound Pair Effort Matrix

| Setup (Time and effort | | | | |
|---|---|---|---|---|
| needed to prepare for the | | | | |
| second train once the first | | Following Train Type (Outgoing) [symbol] | | |
| train has been processed) | | Z | Q | S |
| Preceding | Z | Little effort needed | Little effort needed | Little effort needed |
| Train Type | | Hitch cars need to be | Deep well cars need to be | More hostlers needed |
| (Outbound → | | brought in | brought in | |
| Ramped → | Q | Chassis need to be cleared | Chassis need to be cleared to | Chassis need to be cleared |
| Departed) ¹ | | to make room for next train | make room for next train | to make room for next train |
| | S | Chassis need to be cleared | Chassis need to be cleared to | Chassis need to be cleared |
| | | to make room for next train | make room for next train | to make room for next train |

As can be seen, Table 4 shows the cost of processing the outbound-outbound pair in terms of setup and resources shared for various types of trains (e.g., Z, Q, and S).

The sequence cost manager 323 evaluates each candidate sequence against these effort matrices to derive a quantifiable cost metric. This metric reflects the cumulative effort and resource expenditure for the sequence, encompassing all associated setup and processing activities. The cost determination process is designed to be granular, capturing the nuances of each sequence's resource dynamics, including any potential savings achieved through the efficient reuse of resources between sequential train assignments.

By quantifying the cost in this manner, the sequence cost manager 323 provides a pivotal input to the optimization process. This input enables the sequence optimizer 324 to make informed decisions when selecting the optimized track-train assignment sequence that minimizes resource consumption and operational effort, enhancing the overall efficiency of the hub's ramp operations.

Sequence optimizer 324 may be configured to determine and select the optimum track-train assignment sequence from the set of candidate sequences. In embodiments, the optimum track-train assignment sequence may include a sequence characterized by its capacity to deliver the highest benefit to the hub's ramp operations. The benefits may be quantifiable and may include, but are not limited to, maximized on-time performance, optimized total processing time, and optimized track utilization. The determination of the optimized sequence is based upon the comprehensive analysis of costs associated with each candidate track-train assignment sequence, as evaluated by the sequence cost manager 323.

Sequence optimizer 324 may employ a sophisticated decision-making framework that integrates a multitude of factors, including the operational constraints of the hub, the objectives delineated for ramp operations, and the intricate dynamics of resource allocation and train scheduling. By synthesizing this information, sequence optimizer 324 may determine the sequence that not merely minimizes costs but also aligns with the strategic goals of the hub, such as enhancing throughput, reducing bottlenecks, and ensuring the timely movement of trains through the facility.

In executing its functionality, sequence optimizer 324 may utilize advanced optimization algorithms that are capable of processing vast datasets and complex operational scenarios. These algorithms are designed to navigate the potential trade-offs between different operational objectives, ensuring that the selected sequence represents the optimum balance between cost-efficiency and operational efficacy.

Furthermore, sequence optimizer 324 may be configured to dynamically adjust to real-time changes within the hub's operational environment. This may include responding to unforeseen events, such as delays or early arrivals of trains, and adjusting the track-train assignment sequence accordingly to maintain the integrity of the optimized operating schedule.

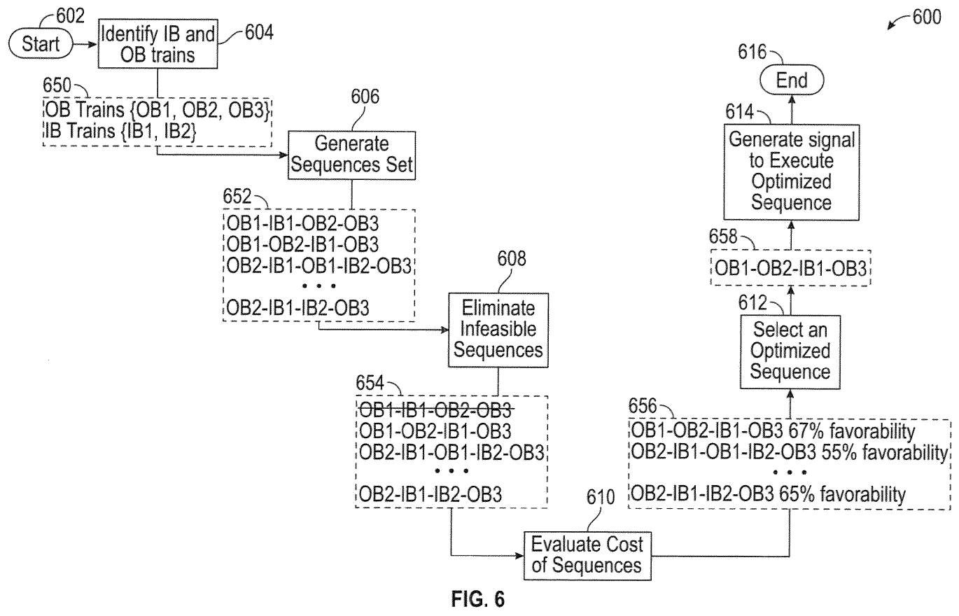

FIG. 6 is a flowchart illustrating operations of a ramp operations optimization system (e.g., ramp operations optimization system 128 of FIGS. 2 and 3) configured with functionality for optimizing ramp operations of a hub in accordance with embodiments of the present disclosure. The optimization process begins at block 602, where the system initiates the sequence of operations designed to optimize the utilization of ramp operations within the hub. This is the starting point of the optimization process, setting the stage for the subsequent steps. At block 604, the ramp operations optimization system identifies inbound and outbound trains scheduled to traverse the hub within the planning horizon of an optimized operating schedule. In embodiments, the operations to identify the inbound and outbound trains at block 604 may leverage functionality of an IB/OB train schedule manager (e.g., IB/OB train schedule manager 320 as illustrated in and described with reference to FIG. 3). In this example, the ramp operations optimization system may identify the following inbound and outbound trains: outbound trains{OB1, OB2, OB3}, inbound trains={IB1,IB2}.

At block 606, the ramp operations optimization system generates a set of candidate track-train assignment sequences over the planning horizon for each production track and the inbound and outbound trains identified at step 604. In embodiments, the operations to generate a set of candidate track-train assignment sequences at block 606 may leverage functionality of a track-train assignment sequence generator (e.g., track-train assignment sequence generator 321 as illustrated in and described with reference to FIG. 3). In this example, the ramp operations optimization system may generate the following set of candidate track-train assignment sequences: {OB1-IB1-OB2-OB3, OB1-OB2-IB1-OB3, OB2-IB1-OB1-IB2-OB3, . . . , OB2-IB1-IB2-OB3}. It is noted that, for the sake of brevity, not all potential sequences have been included in the set shown herein.

At block 608, the ramp operations optimization system identifies and eliminates or prunes infeasible sequences from the set of candidate track-train assignment sequences generated at step 604. In embodiments, the operations to prune infeasible sequences may leverage functionality of a sequence pruning manger (e.g., sequence pruning manger 322 as illustrated in and described with reference to FIG. 3). In this example, the ramp operations optimization system may prune the set of candidate track-train assignment sequences as follows: { [symbol] OB1-OB2-IB1-OB3, OB2-IB1-OB1-IB2-OB3, . . . , OB2-IB1-IB2-OB3}. In this case, the crossed sequence has been pruned from the set of candidate track-train assignment sequences.

At block 610, the ramp operations optimization system determines the cost associated with each candidate track-train assignment sequence in the pruned set of candidate track-train assignment sequences based on one or more effort matrices. In embodiments, the operations to determine the cost associated with each candidate track-train assignment sequence may leverage functionality of a sequence cost manger (e.g., sequence cost manger 323 as illustrated in and described with reference to FIG. 3). In this example, the ramp operations optimization system may determine the cost, and may quantify the cost for each candidate track-train assignment sequences in the set. For example, OB1-OB2-IB1-OB3 sequence may be found to have a 67% favorability, OB2-IB1-OB1-IB2-OB3 sequence may be found to have a 55% favorability, . . . , and OB2-IB1-IB2-OB3 sequence may be found to have a 65% favorability.

At block 612, the ramp operations optimization system may optimize and identify the track-train assignment sequence that yields the maximum benefit. In embodiments, the operations to optimize and identify the track-train assignment sequence that yields the maximum benefit may leverage functionality of a sequence optimizer (e.g., sequence optimizer 324 as illustrated in and described with reference to FIG. 3). In this example, the ramp operations optimization system may optimize and identify the OB1-OB2-IB1-OB3 sequence as providing the maximum benefit, as it is found to have a 67% favorability, highest among all the sequences in the set. In this case, the ramp operations optimization system may select the OB1-OB2-IB1-OB3 sequence as the optimized sequence and may, at block 614, generate signal to execute the optimized sequence (e.g., during execution of the optimized operating schedule) and/or may include the optimized sequence as part of the ramp plan over the planning horizon. Operations end at block 616.

It is noted that, in embodiments, the process illustrated in FIG. 6 may be performed for each production track of the hub, in which case the optimized sequence selected at block 612 represents a sequence of trains for a single production track. In additional or alternative embodiments, the process illustrated in FIG. 6 may be performed for a plurality of production tracks of the hub, in which case the optimized sequence selected at block 612 represents a sequence of trains for multiple production tracks (e.g., processed on multiple tracks concurrently and/or sequentially).

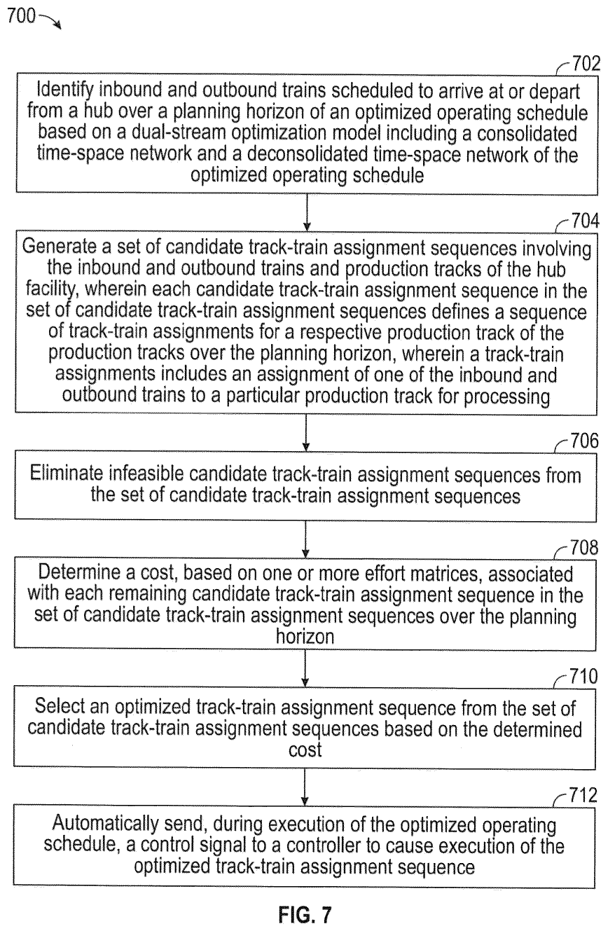

FIG. 7 shows a high-level flow diagram 700 of operation of a system configured for providing functionality for optimizing ramp operations of a hub in accordance with embodiments of the present disclosure. For example, the functions illustrated in the example blocks shown in FIG. 7 may be performed by system 100 of FIG. 1 according to embodiments herein. In embodiments, the operations of the method 700 may be stored as instructions that, when executed by one or more processors, cause the one or more processors to perform the operations of the method 700.

At block 702, inbound and outbound trains scheduled to arrive at or depart from a hub over a planning horizon of an optimized operating schedule are identified based on a dual-stream optimization model including a consolidated time-space network and a deconsolidated time-space network of the optimized operating schedule. In embodiments, functionality of a IB/OB train schedule manager (e.g., IB/OB train schedule manager 320 as illustrated in FIG. 3) may be used to identify inbound and outbound trains scheduled to arrive at or depart from a hub over a planning horizon of an optimized operating schedule based on a dual-stream optimization model including a consolidated time-space network and a deconsolidated time-space network of the optimized operating schedule. In embodiments, the IB/OB train schedule manager may perform operations to identify inbound and outbound trains scheduled to arrive at or depart from a hub over a planning horizon of an optimized operating schedule based on a dual-stream optimization model including a consolidated time-space network and a deconsolidated time-space network of the optimized operating schedule according to operations and functionality as described above with reference to IB/OB train schedule manager 320 and as illustrated in FIGS. 1-6.

At block 704, a set of candidate track-train assignment sequences involving the inbound and outbound trains and production tracks of the hub facility is generated. In embodiments, each candidate track-train assignment sequence in the set of candidate track-train assignment sequences defines a sequence of track-train assignments for a respective production track of the production tracks over the planning horizon, and a track-train assignments includes an assignment of one of the inbound and outbound trains to a particular production track for processing. In embodiments, functionality of a track-train assignment sequence generator (e.g., track-train assignment sequence generator 321 as illustrated in FIG. 3) may be used to generate a set of candidate track-train assignment sequences involving the inbound and outbound trains and production tracks of the hub facility. In embodiments, the track-train assignment sequence generator may perform operations to generate a set of candidate track-train assignment sequences involving the inbound and outbound trains and production tracks of the hub facility according to operations and functionality as described above with reference to track-train assignment sequence generator 321 and as illustrated in FIGS. 1-6.

At block 706, infeasible candidate track-train assignment sequences are eliminated from the set of candidate track-train assignment sequences. In embodiments, functionality of a sequence pruning manger (e.g., pruning manger 322 as illustrated in FIG. 3) may be used to eliminate infeasible candidate track-train assignment sequences from the set of candidate track-train assignment sequences. In embodiments, the pruning manger 322 may perform operations to eliminate infeasible candidate track-train assignment sequences from the set of candidate track-train assignment sequences according to operations and functionality as described above with reference to pruning manger 322 and as illustrated in FIGS. 1-6.

At block 708, a cost associated with each remaining candidate track-train assignment sequence in the set of candidate track-train assignment sequences over the planning horizon is determined based on one or more effort matrices. In embodiments, functionality of a sequence cost manger (e.g., sequence cost manger 323 as illustrated in FIG. 3) may be used to determine a cost, based on one or more effort matrices, associated with each remaining candidate track-train assignment sequence in the set of candidate track-train assignment sequences over the planning horizon. In embodiments, the sequence cost manger may perform operations to determine a cost, based on one or more effort matrices, associated with each remaining candidate track-train assignment sequence in the set of candidate track-train assignment sequences over the planning horizon according to operations and functionality as described above with reference to sequence cost manger 323 and as illustrated in FIGS. 1-6.

At block 710, an optimized track-train assignment sequence is selected from the set of candidate track-train assignment sequences based on the determined cost. In embodiments, functionality of a sequence optimizer (e.g., sequence optimizer 324 as illustrated in FIG. 3) may be used to select an optimized track-train assignment sequence from the set of candidate track-train assignment sequences based on the determined cost. In embodiments, the sequence optimizer may perform operations to select an optimized track-train assignment sequence from the set of candidate track-train assignment sequences based on the determined cost according to operations and functionality as described above with reference to sequence optimizer 324 and as illustrated in FIGS. 1-6.

At block 712, a control signal is automatically sent to a controller to cause execution of the optimized track-train assignment sequence. In embodiments, functionality of an operations server (e.g., operations server 125 as illustrated in FIGS. 1-3) may be used automatically send, during execution of the optimized operating schedule, a control signal to a controller to cause execution of the optimized track-train assignment sequence. In embodiments, the operations server may perform operations to automatically send, during execution of the optimized operating schedule, a control signal to a controller to cause execution of the optimized track-train assignment sequence according to operations and functionality as described above with reference to operations server 125 and as illustrated in FIGS. 1-6.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-7 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for optimizing ramp operations in a hub facility, the method comprising:
identifying inbound and outbound trains scheduled to arrive at or depart from a hub over a planning horizon of an optimized operating schedule based on a dual-stream optimization model including a consolidated time-space network and a deconsolidated time-space network of the optimized operating schedule;
generating a set of candidate track-train assignment sequences involving the inbound and outbound trains and production tracks of the hub facility, wherein each candidate track-train assignment sequence in the set of candidate track-train assignment sequences defines a sequence of track-train assignments for a respective production track of the production tracks over the planning horizon, wherein a track-train assignments includes an assignment of one of the inbound and outbound trains to a particular production track for processing;
eliminating infeasible candidate track-train assignment sequences from the set of candidate track-train assignment sequences;
determining a cost, based on one or more effort matrices, associated with each remaining candidate track-train assignment sequence in the set of candidate track-train assignment sequences over the planning horizon;
selecting an optimized track-train assignment sequence from the set of candidate track-train assignment sequences based on the determined cost; and
automatically sending, during execution of the optimized operating schedule, a control signal to a controller to cause execution of the optimized track-train assignment sequence.

2. The method of claim 1, wherein an infeasible candidate track-train assignment sequence is a sequence that includes a track-train assignment for a first train followed by a track-train assignment for a second train to the same production track in which a time for processing the first train overlaps the processing time for the second train.

3. The method of claim 1, wherein an infeasible candidate track-train assignment sequence is a sequence that includes one or more track-train assignments for one or more respective trains to be processed during one or more time increments of the planning horizon that are implausible to perform with resources predicted to be available during the one or more time increments.

4. The method of claim 1, wherein identifying inbound and outbound trains scheduled to arrive at or depart from the hub over the planning horizon of the optimized operating schedule includes analyzing an active train schedule for the hub to determine the arrival and departure times of the inbound and outbound trains within the planning horizon.

5. The method of claim 1, wherein identifying inbound and outbound trains scheduled to arrive at or depart from the hub over the planning horizon of the optimized operating schedule includes predicting the inbound and outbound trains scheduled to arrive at or depart from the hub based on historical data.

6. The method of claim 1, wherein generating the set of candidate track-train assignment sequences is based on one or more of a predicted volume of units, resources predicted to be available at the hub, and constraints of the consolidated time-space network and the deconsolidated time-space network.

7. The method of claim 1, wherein eliminating infeasible candidate track-train assignment sequences from the set of candidate track-train assignment sequences includes evaluating a compatibility of train types and processing requirements for sequential assignments on the same production track.

8. The method of claim 1, wherein determining the cost associated with each remaining candidate track-train assignment sequence in the set of candidate track-train assignment sequences over the planning horizon includes quantifying an effort necessitated to position a latter train in a train pair of a candidate track-train assignment sequence, on the heels of departure of a former train in the train pair, while considering the constraints of the dual-stream optimization model.

9. The method of claim 1, wherein selecting the optimized track-train assignment sequence from the set of candidate track-train assignment sequences based on the determined cost includes using a mathematical optimization model to minimize the total cost across all candidate track-train assignment sequences, taking into account operational constraints and objectives of the hub.

10. A system configured for optimizing ramp operations in a hub facility, comprising:
at least one processor; and
a memory operably coupled to the at least one processor and storing processor-readable code that, when executed by the at least one processor, is configured to perform operations including:
identifying inbound and outbound trains scheduled to arrive at or depart from a hub over a planning horizon of an optimized operating schedule based on a dual-stream optimization model including a consolidated time-space network and a deconsolidated time-space network of the optimized operating schedule;
generating a set of candidate track-train assignment sequences involving the inbound and outbound trains and production tracks of the hub facility, wherein each candidate track-train assignment sequence in the set of candidate track-train assignment sequences defines a sequence of track-train assignments for a respective production track of the production tracks over the planning horizon, wherein a track-train assignments includes an assignment of one of the inbound and outbound trains to a particular production track for processing;
eliminating infeasible candidate track-train assignment sequences from the set of candidate track-train assignment sequences;
determining a cost, based on one or more effort matrices, associated with each remaining candidate track-train assignment sequence in the set of candidate track-train assignment sequences over the planning horizon;
selecting an optimized track-train assignment sequence from the set of candidate track-train assignment sequences based on the determined cost; and
automatically sending, during execution of the optimized operating schedule, a control signal to a controller to cause execution of the optimized track-train assignment sequence.

11. The system of claim 10, wherein an infeasible candidate track-train assignment sequence is a sequence that includes a track-train assignment for a first train followed by a track-train assignment for a second train to the same production track in which a time for processing the first train overlaps the processing time for the second train.

12. The system of claim 10, wherein an infeasible candidate track-train assignment sequence is a sequence that includes one or more track-train assignments for one or more respective trains to be processed during one or more time increments of the planning horizon that are implausible to perform with resources predicted to be available during the one or more time increments.

13. The system of claim 10, wherein identifying inbound and outbound trains scheduled to arrive at or depart from the hub over the planning horizon of the optimized operating schedule includes analyzing an active train schedule for the hub to determine the arrival and departure times of the inbound and outbound trains within the planning horizon.

14. The system of claim 10, wherein identifying inbound and outbound trains scheduled to arrive at or depart from the hub over the planning horizon of the optimized operating schedule includes predicting the inbound and outbound trains scheduled to arrive at or depart from the hub based on historical data.

15. The system of claim 10, wherein generating the set of candidate track-train assignment sequences is based on one or more of a predicted volume of units, resources predicted to be available at the hub, and constraints of the consolidated time-space network and the deconsolidated time-space network.

16. The system of claim 10, wherein eliminating infeasible candidate track-train assignment sequences from the set of candidate track-train assignment sequences includes evaluating a compatibility of train types and processing requirements for sequential assignments on the same production track.

17. The system of claim 10, wherein determining the cost associated with each remaining candidate track-train assignment sequence in the set of candidate track-train assignment sequences over the planning horizon includes quantifying an effort necessitated to position a latter train in a train pair of a candidate track-train assignment sequence, on the heels of departure of a former train in the train pair, while considering the constraints of the dual-stream optimization model.

18. The system of claim 10, wherein selecting the optimized track-train assignment sequence from the set of candidate track-train assignment sequences based on the determined cost includes using a mathematical optimization model to minimize the total cost across all candidate track-train assignment sequences, taking into account operational constraints and objectives of the hub.

19. A computer-based tool for optimizing ramp operations in a hub facility, the computer-based tool including non-transitory computer readable media having stored thereon computer code which, when executed by a processor, causes a computing device to perform operations comprising:
identifying inbound and outbound trains scheduled to arrive at or depart from a hub over a planning horizon of an optimized operating schedule based on a dual-stream optimization model including a consolidated time-space network and a deconsolidated time-space network of the optimized operating schedule;
generating a set of candidate track-train assignment sequences involving the inbound and outbound trains and production tracks of the hub facility, wherein each candidate track-train assignment sequence in the set of candidate track-train assignment sequences defines a sequence of track-train assignments for a respective production track of the production tracks over the planning horizon, wherein a track-train assignments includes an assignment of one of the inbound and outbound trains to a particular production track for processing;
eliminating infeasible candidate track-train assignment sequences from the set of candidate track-train assignment sequences;
determining a cost, based on one or more effort matrices, associated with each remaining candidate track-train assignment sequence in the set of candidate track-train assignment sequences over the planning horizon;
selecting an optimized track-train assignment sequence from the set of candidate track-train assignment sequences based on the determined cost; and
automatically sending, during execution of the optimized operating schedule, a control signal to a controller to cause execution of the optimized track-train assignment sequence.

20. The computer-based tool of claim 19, wherein an infeasible candidate track-train assignment sequence is a sequence that includes a track-train assignment for a first train followed by a track-train assignment for a second train to the same production track in which a time for processing the first train overlaps the processing time for the second train.
